(19) United States
(12) Patent Application Publication
(10) Pub. No.: US 2005/0034439 A1
(43) Pub. Date: Feb. 17, 2005

(54) Attachment for a sugarcane harvester

(76) Inventor: Emanuel Joseph Galea, Pleystowe (AU)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/850,965

(22) Filed: May 21, 2004

(30) Foreign Application Priority Data
May 23, 2003 (AU) 2003902542

(51) Int. Cl. A01D 34/00

(52) U.S. Cl. 56/51

(57) ABSTRACT

An attachment for a sugarcane harvester allows two rows of cane to be harvested at the same time. The attachment is simple and robust in design and comprises an inclined large rectangular guide plate which diverges outwardly from one side of the sugarcane harvester to intercept the adjacent row of cane. At the bottom of the guide plate and in a front part of the guide plate is a cutting wheel to cut the row of cane. At the bottom of the guide plate and in a rear part of the guide plate is a second rotating wheel containing projections or paddles to assist in passing the cane into the sugarcane harvester. The attachment does not require complicated arrangements to enable the second row of cane to be cut.

### FIELD OF THE INVENTION

This invention is directed to an attachment that can be attached to a sugarcane harvester to enable the harvester to process two rows of sugarcane in a single pass as opposed to a single row of sugarcane that conventional sugarcane harvesters process. The invention is also directed to a sugarcane harvester having such an attachment.

### BACKGROUND ART

A sugarcane harvester is a self-propelled machine that travels along a sugarcane field to harvest the sugarcane. Many types of harvesters are known and FIG. 1 illustrates a particular conventional type of harvester. These harvesters typically have a forward topper that cuts the bushy top parts off the sugarcane plant. A pair of spiral crop dividers is positioned in front of the harvester to divide the crop and also to straighten the sugarcane stalks. A cutter cuts the base of the sugarcane plants. The plants are fed into the harvesting machine that cuts the plants into short lengths called billets. The billets are passed onto an elevator which passes the billets into an adjacent truck or trailer.

These harvesters travel along the sugarcane field and harvest a single row of cane at a time. There would be an advantage if it were possible for the harvester to harvest more than one row of cane at a time. There would also be an advantage if it were possible to harvest more than one row of cane at a time but still using a single operator in the harvester.

It is known to modify a sugarcane harvester to provide an additional cutter which will cut a second row of cane and lay the second row of cane on the ground while the first row of cane is being harvested. The second row of cane can then be picked up later on. However, this is not particularly efficient. Alternatively a tractor can be fitted with the additional cutter to cut the second row of cane, the tractor reversing over the cane field. This requires two personnel to operate the tractor/cutter.

The present invention is directed to an attachment that can be attached to a conventional harvester and which enables the harvester to cut and process at least two rows of cane during a single pass. The present invention is also directed to a harvester having such an attachment or arrangement.

It will be clearly understood that, if a prior art publication is referred to herein, this reference does not constitute an admission that the publication forms part of the common general knowledge in the art in Australia or in any other country.

### OBJECT OF THE INVENTION

It is an object of the invention to provide an attachment and a harvester which may at least partially overcome some of the above-mentioned disadvantages or provide the public with a useful or commercial choice.

In one form, the invention resides in an attachment for a sugarcane harvester, the attachment comprising a support means which, in use, extends to one side of the harvester, a cutter to cut an adjacent row of cane, and means to guide the cut adjacent row of cane into the harvester.

In this manner, the attachment can be used to cut the adjacent row of cane (this being the row next to the row which is being naturally harvested by the harvester) and to feed this cane into the harvester for the usual processing (which typically includes cutting into bolts etc).

The attachment can be attached to a conventional harvester. Alternatively, a harvester can be purpose-built with the attachment, and both interpretations should be given to the word “attachment”.

The support means may comprise one or more elongate members which extend to one side of the harvester. The term “extend to one side of the harvester” includes extending forwardly and to one side of the harvester, or next to the harvester etc. The interpretation is to mean that the support means can intercept the adjacent row of cane.

The support means may comprise an elongate framework which may be arranged in a substantial upright manner. A guide means such as a guide wheel, slide and the like may be provided on or adjacent the support means to support the support means above the ground surface as the harvester travels along a row of cane.

A cutter is present to cut the adjacent row of cane. The cutter is typically a base cutter to cut the cane adjacent the ground. The cutter may comprise a rotating cutting wheel containing one or more cutting knives, blades etc. A plurality of cutters may be provided. The cutter may be a rotating cutter which rotates towards the harvester to facilitate passage of the cut cane towards the harvester. The cutter is typically supported by the support means. The cutter may be powered by any suitable means and this may include a hydraulic motor, a pneumatic motor, and electric motor, or other types of drive means. Typically, the cutter is driven by a hydraulic motor which is powered by the harvester. The size of the cutter can vary to suit. A cutter having a rotating cutting disk with a diameter of between 40-200 cm may suit.

The attachment includes means to guide the cut adjacent row of cane towards the harvester. The means may comprise part of the support means. For instance, the support means may comprise a vertical or angled sheet member which guides the cut cane into the harvester as the harvester moves forwardly. The sheet member may comprise a substantially continuous sheet member such as a steel sheet. Alternatively, the sheet member may comprise perforations, slots, have a grid like or bar like configuration. A plurality of smaller members may be provided which may be arranged to form at least part of a guide means. The sheet member is preferably substantially planar but it may also be curved or otherwise shaped to facilitate guiding of the cane into the harvester. The sheet member may be hinged to enable it to fold towards the harvester during transportation, or may be segmented.

The means to guide the cut adjacent row of cane into the harvester may additionally or alternatively comprise a “kicker” to assist in feeding the cane into the harvester and also to orientate the cane to enable it to be fed into the harvester with greater ease.

The kicker may comprise a device that can resemble a wheel but which contains projections on the wheel to assist in the orientation of the cane into the right position for picking up by the harvester. The projections may comprise paddles.

### BRIEF DESCRIPTION OF THE DRAWINGS

An embodiment of the invention will be described with reference to the following drawings:

FIG. 1. Illustrates a known type of harvester.

FIG. 2. Illustrates a front view of a harvester containing an attachment according to an embodiment of the invention.

FIG. 3. Illustrates the attachment and particularly illustrating the sheet like configuration of the attachment.

FIG. 4. Illustrates the attachment from the other side of that illustrated in FIG. 3 and particularly illustrating a guide wheel, and the cutter.

FIG. 5. Illustrates a close-up view of the cutter.

FIG. 6. Illustrates the cutter and also illustrates the “kicker”.

FIG. 7. Illustrates the cutter of FIG. 6 from the other side of the attachment and again illustrates the “kicker”.

### BEST MODE

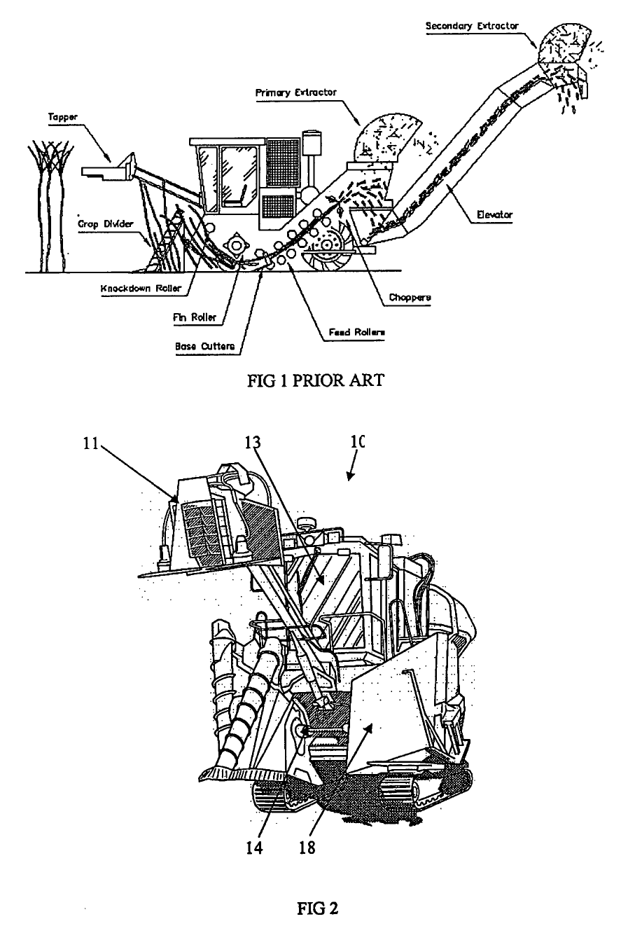

Referring to the drawings and initially to FIG. 1 there is illustrated a conventional type of sugarcane harvester. The main features of the harvester are identified.

Referring to FIG. 2 there is illustrated a known type of harvester 10 containing an attachment according to an embodiment of the invention. The harvester 10 is illustrated as having a topper 11, a divider/straightener 12 in the form of an elongate steel member formed with a spiral flight (this being known), an operator cabin 13 and an intake area 14 into which the cut sugarcane passes into the harvester. In this particular embodiment, harvester 10 is a track harvester but it should be appreciated that the harvester may also comprise a wheel harvester.

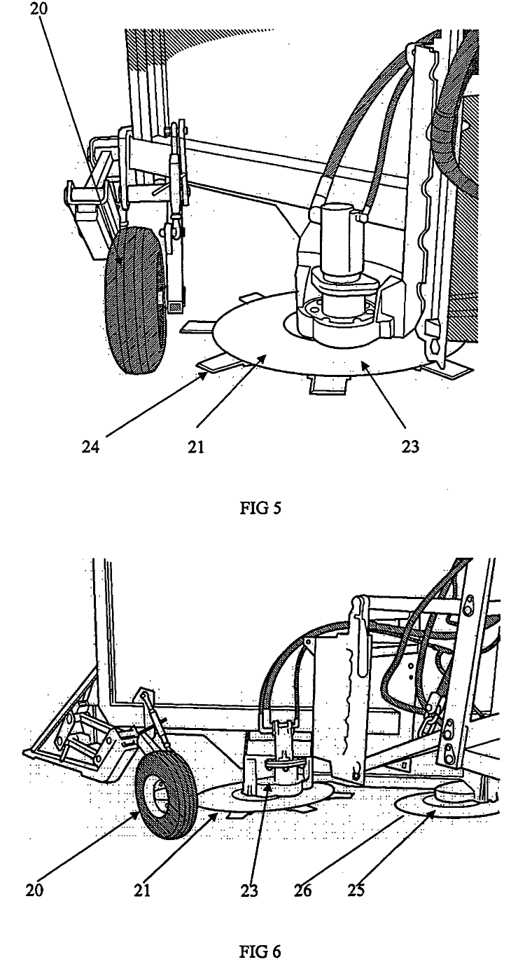

Referring to FIG. 4, attachment 15 is attached to the front and one side of harvester 10 using a strong supporting framework 16. This is in the form of steel sections which are welded or bolted together and attached to the harvester. The way that the attachment is attached to the harvester can vary but typically one part attaches to the side of the harvester and another part attaches to the front of the harvester. Lifting rams 17 are provided to enable the entire attachment to be lifted and lowered relative to the ground surface. The rams are hydraulically powered by the harvester.

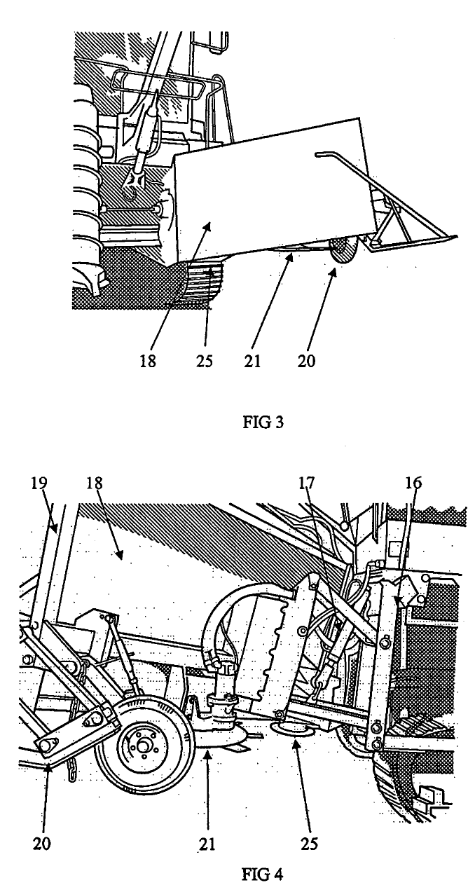

The main part of the attachment is a large sheet member 18 which is made of steel and which is supported by a surrounding steel frame 19. Sheet member 18 assists in guiding the adjacent row of cut cane into the intake area 14 of harvester 10. Therefore, the orientation of the sheet member, in use, is substantially as illustrated in FIGS. 2 and 3 and is forwardly of the harvester 10 but diverging slightly outwardly to form an inclined guide to feed the cut sugarcane into the harvester. The sheet member is also generally upright but is inclined slightly rearwardly, again to assist in funnelling the cut sugarcane into the harvester.

In front of sheet member 18 is a guide wheel assembly 20 which is best illustrated in FIGS. 4-6. The guide wheel assembly contains a pneumatic wheel that rides along the ground to support the forward part of the attachment above the ground surface.

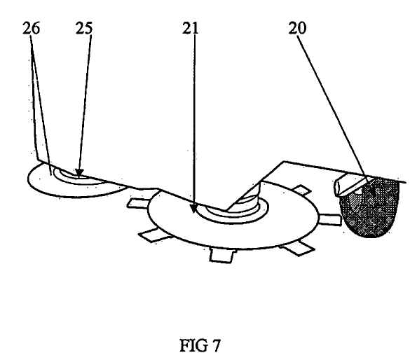

A cutter 21 is position behind the guide wheel and extends below the bottom edge of sheet member 18. Cutter 21 is best illustrated in FIGS. 4, 5, 6, 7. Cutter 21 comprises a substantially horizontal circular cutting disk 22 which rotates about a substantially vertical axis. Cutter 21 is driven by a hydraulic motor 23 which is powered by the harvester. A plurality of cutting blades 24 extend from the edge of cutting disk 22 , this being best illustrated in FIG. 5. The diameter of cutter 21 can vary but will typically be between 20-100 cm. Cutter 21 is made of steel and can have a thickness of between 3-10 mm. Cutter 21 rotates towards the intake area 14 of harvester 10. For instance, the cutter as illustrated in FIG. 5 will rotate in a clockwise direction. The function of cutter 21 is to cut the base of the adjacent row of sugarcane.

Behind the cutter 21 and also extending below the bottom of sheet member 18 is a second device which facilitates orientation and passage of the cut sugarcane into the harvester. The second device is a “kicker” 25 and again comprises a driven and rotating disk. However, the disk is not provided with cutting blades, and instead contains a number of projections 26 extending from the top face of the disk. The second disk causes the cut cane to adopt the right position for picking up by harvester 10. The second disk and the first disk can overlap.

In use, attachment 15 can be attached to a conventional harvester. The attachment allows the harvester to normally harvest the row of cane immediately in front of the harvester but also to harvest the adjacent row of cane at the same time. When not required, the attachment can be removed from the harvester. Of course, a “purpose-built” harvester can also be manufactured which contains the attachment as an integral part of the harvester.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

It should be appreciated that various other changes and modifications can be made to any embodiment described without departing from the spirit and scope of the invention.

1. An attachment for a sugarcane harvester and to enable a row of cane and an adjacent row of cane to be processed, the attachment comprising a support means in the form of a sheet member which, in use, extends to one side of the harvester, a cutter to cut the adjacent row of cane, and means to guide the cut adjacent row of cane into the harvester.

2. The attachment of claim 1, wherein the sheet member comprises a substantially planar plate member.

3. The attachment of claim 1, wherein a ground traversable guide means such as a guide wheel or slide is provided to support the support means above the ground surface as the harvester travels along a row of cane.

4. The attachment of claim 3, wherein the guide means is attached relative to the support means.

5. The attachment as claimed in claim 1, wherein the sheet member has a substantially flat front face which contacts the adjacent row of cane.

6. The attachment as claimed in claim 1, wherein the cutter is a circular cutting disc which rotates about a substantially vertical axis and is positioned adjacent a lower portion of the support means to cut the adjacent row of cane.

7. The attachment as claimed in claim 6, wherein the cutter is driven by a motor which is positioned on a rear face of the support means which does not contact the adjacent row of cane.

8. The attachment as claimed in claim 7, wherein the support means diverges out from the intake area of the harvester to assist in guiding cut cane to the intake area.

9. The attachment as claimed in claim 1, wherein the means to guide the cane comprises a rotating wheel positioned adjacent a lower portion of the support means and adjacent the intake area of the harvester.

10. The attachment of claim 9, wherein the wheel is provided with at least one upstanding paddle.

11. The attachment as claimed in claim 1, comprising a link assembly to attach the attachment to the harvester in a manner to allow the attachment to be raised and lowered.

12. The attachment of claim 11 including a ram to lift and lower the attachment.
